(19) United States
(12) Patent Application Publication
(10) Pub. No.: US 2026/0210416 A1
(43) Pub. Date: Jul. 23, 2026

(54) FLOATING BRAKE CALIPER

(71) Applicant: RAICAM DRIVELINE S.R.L., Mondovi', Cuneo (IT)

(72) Inventors: Sandro BONARDO, Peveragno, Cuneo (IT); Francesco VALVANO, Cuneo (IT)

(73) Assignee: RAICAM DRIVELINE S.R.L., Mondovi', Cuneo (IT)

(21) Appl. No.: 19/144,475

(22) PCT Filed: Dec. 21, 2023
(86) PCT No.: PCT/IB2023/063112

§ 371 Date: Jun. 29, 2025

(30) Foreign Application Priority Data
Dec. 29, 2022 (IT) 102022000027102

(51) Int. Cl. F16D 55/227; F16D 55/00; F16D 65/00; F16D 65/18; F16D 121/04

(52) U.S. Cl. CPC F16D 55/227; F16D 65/0056; F16D 65/0068; F16D 65/0087; F16D 2055/0008; F16D 2055/0016; F16D 65/18; F16D 2121/04

(57) ABSTRACT

A brake caliper for a two-wheel vehicle has at least one piston, a stationary supporting portion attachable to the two-wheel vehicle, and two brake pads each having a backing plate having a pair of opposing side faces extending in use in a substantially radial direction relative to an axis of rotation of a wheel of the two-wheel vehicle. The brake caliper has a sliding block having two end plates between which a rigid body of plastic material is interposed and locked. The stationary supporting portion has an abutment surface facing one side face of the pair of opposing side faces. The sliding block forms a recess that accommodates the two brake pads and allows the two brake pads to reach a stable abutment position against the abutment surface of the stationary supporting portion during braking.

### TECHNICAL FIELD

The present invention relates to a floating brake caliper partially made of a plastic material. In particular, but not exclusively, the present brake caliper is applicable to two-wheeled vehicles, such as bicycles.

### BACKGROUND ART

Floating brake calipers for two-wheeled vehicles typically comprise a stationary supporting portion, fixed to the vehicle, and a sliding block that can slide relative to the support portion and the brake disc along a direction parallel to the axis of rotation of the brake disc. The sliding block has an overall C shape, and comprises a bridge portion to the distal ends of which is connected a respective side portion extending transversally to the bridge portion. This geometry allows the sliding block to straddle the brake disc, with the side portions facing the braking surfaces of the brake disc. One face of the side portion facing the brake disc is traditionally configured to accommodate a cylinder or piston. Interposed between the piston and the braking surface of the brake disc is a brake pad that during braking is urged towards the brake disc by the piston to generate a braking force. The loads generated during braking are mainly transmitted from the pads to the sliding block.

As is well known, the sliding block of a brake caliper for two-wheeled vehicles is made of a metallic material, typically aluminium or steel, with the purpose of withstanding the loads to which it is subjected during braking and transferring these loads to the vehicle structure. Manufacturing costs of these sliding blocks are high due to both the choice of materials and the manufacturing process.

US 2022/0381304 A1 discloses a brake caliper comprising two brake pads, a stationary supporting portion attachable to the vehicle, and a block axially movable with respect to the stationary portion. The brake pads are axially movable and capable of being arranged facing two opposing braking surfaces of the brake disc, each brake pad having a backing plate having at least one side face extending in use in a substantially radial direction relative to an axis of rotation of a vehicle wheel.

Conventionally, the sliding block consists of a single monolithic metal body, having an overall substantially C-shape, with two side wings connected by a connecting portion; between the side wings and the connecting portion is an empty space to allow the passage of a peripheral part of a rotating brake disc and to accommodate the two brake pads in an area axially comprised between the side wings.

### SUMMARY OF THE INVENTION

A primary object of the present invention is to provide a lightweight brake caliper. A further object of the present invention is to provide an economical brake caliper. Another scope of the invention is to provide a brake caliper capable of efficiently transferring thermal loads to the environment and braking loads to the vehicle structure.

The above and other objects and advantages, which will be better understood herein after, are achieved by a brake caliper having the features set forth in independent claim 1. Preferred embodiments of the invention are set forth in the dependent claims.

In brief, a floating brake caliper for two-wheeled vehicles comprises one or more pistons, two brake pads each comprising a backing plate having at least one side radially extending towards an axis of rotation of a wheel, a stationary supporting portion fixed to the vehicle and comprising an abutment surface facing one of the sides of each backing plate, and a sliding block, axially movable with respect to the stationary portion and arranged in a bridge, in use, on a brake disc. The sliding block comprises a first and a second end plate and a connecting element for the end plates, made of metallic material. The sliding block further comprises a rigid body of plastic material, interposed and locked between the end plates, and having a recess for accommodating the brake pads. The recess in the rigid plastic body allows the brake pads to achieve a stable stop position against the abutment surface of the stationary supporting portion during braking.

### BRIEF DESCRIPTION OF THE DRAWINGS

The features and advantages of the present invention will be evident from the following description, which is given by way of non-limiting example. Reference is made to the accompanying drawings, in which:

FIG. 1 is a perspective view of an embodiment of a brake caliper according to the invention;

FIG. 2 is a perspective view, from a different angle of view, of the brake caliper in FIG. 1;

FIG. 3 is an exploded perspective view of the brake caliper of FIG. 1;

FIG. 4 is an exploded perspective view of some of the components illustrated in FIG. 3;

FIG. 5 is an exploded perspective view of a block forming part of the brake caliper;

FIG. 6 is a perspective view of the block of FIG. 5 in an assembled condition;

FIG. 7 is a perspective view of a stationary portion of the support forming part of the brake caliper;

FIG. 8 is a perspective view of a condition in which a radially extending side of a brake pad is in abutment against an abutment surface of the stationary supporting portion of the brake caliper during braking;

FIG. 9 is a perspective view of the abutment condition shown in FIG. 8, illustrated with the stationary portion in partial transparency to show some hidden parts;

FIG. 10 is a perspective view of a rigid plastic body forming part of the brake caliper;

FIG. 11 is a perspective view, from a different angle, of the rigid body in FIG. 9;

FIG. 12 is a longitudinal cross-sectional view of the brake caliper in FIG. 1;

FIG. 13 is a cross-sectional view of the brake caliper in FIG. 1;

FIG. 14 is a cross-sectional view of an alternative embodiment of a brake caliper according to the invention;

FIG. 15 is a perspective view of a brake caliper coupled to a vehicle frame and straddling a brake disc; and FIG. 16 is a perspective view, from a different angle, of the brake caliper, frame and brake disc of FIG. 15.

### DETAILED DESCRIPTION

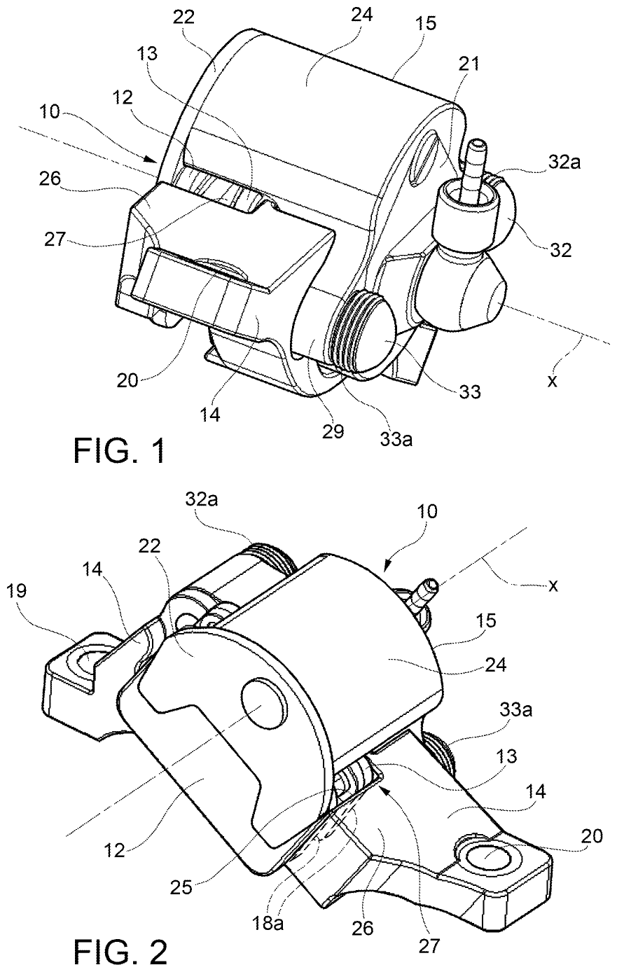

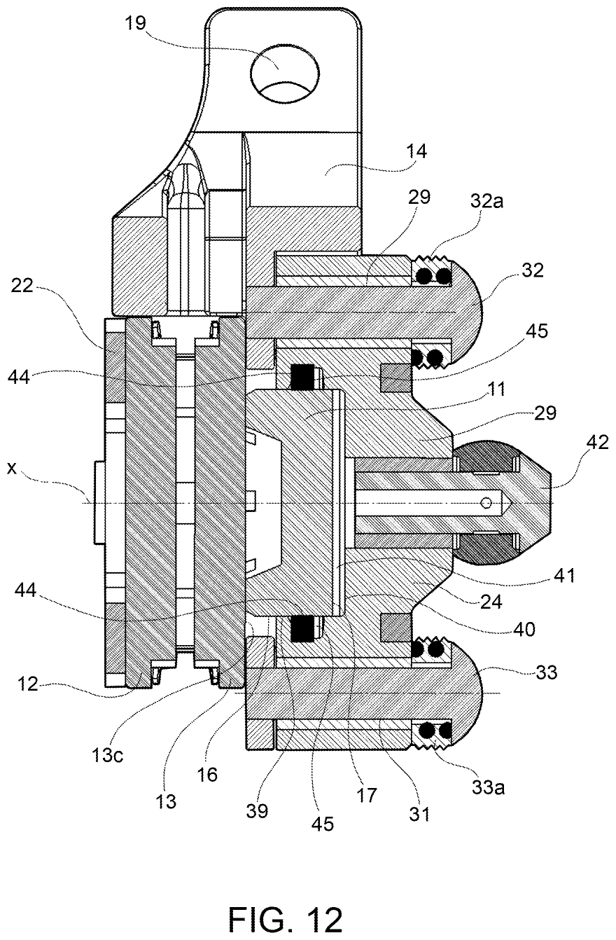

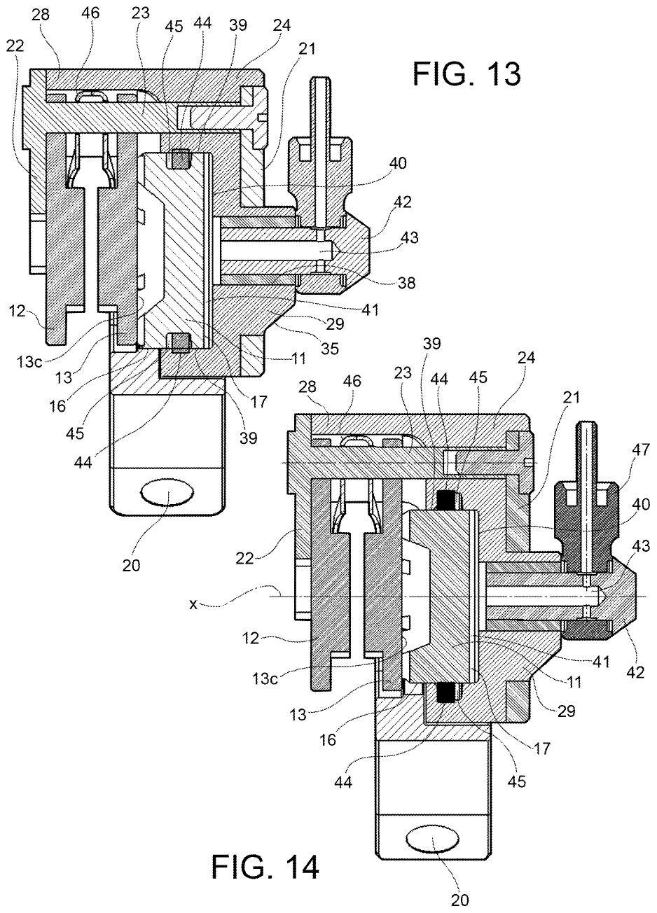

Referring initially to FIGS. 1 to 3, a brake caliper according to an embodiment of the invention will be described. Indicated overall at 10 is a brake caliper for two-wheeled vehicles. The brake caliper typically has an overall C-shape, so that it can be arranged bridging or straddling a brake disc (visible in FIGS. 12, 13), in a per se known manner.

The brake caliper 10 defines a transversal axis x (FIGS. 1-3) that is parallel to the axis of rotation of the brake disc. Throughout the present description and claims, terms and expressions indicating positions, directions and orientations, such as “axial” and “transversal”, are intended to refer to an axis which, in the mounted condition, is parallel to the axis of rotation of the wheel with which the brake caliper is associated. The expression ‘longitudinal’ is to be understood as referring to a direction perpendicular to the direction defined herein as transversal and parallel to the direction of advancement of the vehicle. The expression ‘radial’ is, on the other hand, to be understood as referring to an axis of rotation of the brake disc and, therefore, referring to directions radial to the transversal axis x and lying in vertical planes perpendicular to the transversal axis x. The expression “tangential” is to be construed with reference to the rotation of the brake disc.

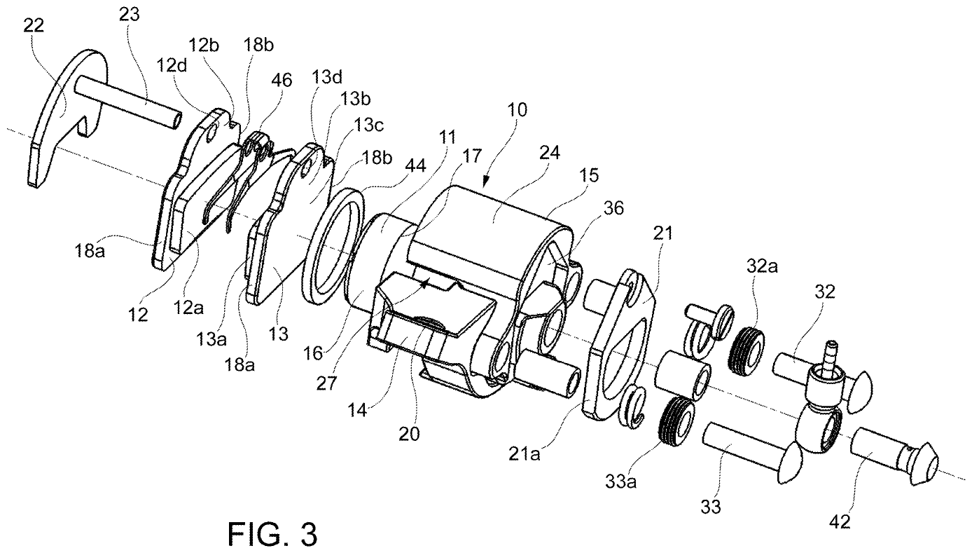

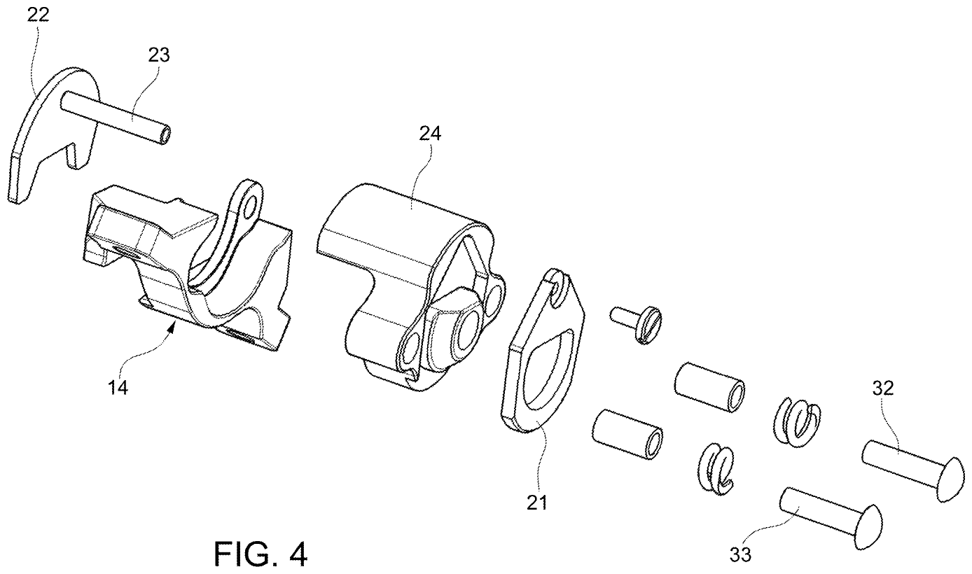

The brake caliper 10 comprises at least one piston 11, two brake pads 12, 13, a stationary supporting portion 14, and a sliding block 15 (FIG. 3), which is transversal to the stationary supporting portion 14.

The piston 11 is typically cylindrical in shape and has a cylindrical side surface 16 and a longitudinal base surface 17.

According to an embodiment, the piston 11 is made of plastic material, e.g. phenolic resins (PF).

Brake pads 12, 13 are arranged on opposite sides of the brake disc and are axially movable along the transversal axis x.

The constructional and functional features of a floating type brake caliper are well known and will therefore not be described in detail here. Suffice it to recall here that during braking, the delivery of pressurised fluid into a hydraulic chamber inside the caliper urges one or more pistons in a transversal direction against a first brake pad and towards a first side of the brake disc. Once a first brake pad has made contact with the brake disc, the pressure of the piston forces the sliding block to move perpendicular to the plane of the brake disc, bringing a second brake pad into contact with a second side of the brake disc, opposite the first side.

Each brake pad 12, 13 comprises a backing plate 12b, 13b, on one face of which a respective layer 12a, 13a of friction material is securely applied, to face in use a respective one of the two opposite braking surfaces of the brake disc. The friction material may typically be a sintered material. In order to be able to withstand the loads present during braking, the backing plates 12b, 13b are typically made of a metallic material, such as iron and its alloys. As is known, actuation of the piston 11 brings the friction materials 12a, 13a into contact with the braking surfaces of the brake disc during braking. The brake pads described and illustrated herein may be of conventional design.

The backing plate 13b has, on a face opposite that facing the brake disc, an engagement surface 13c (FIG. 3) capable of being engaged by the piston 11 to receive a transversal axial thrust from it during braking.

Furthermore, the backing plates 12b, 13b of the brake pads 12, 13 each have a pair of opposing side faces 18a, 18b (FIGS. 3, 8, 9), lying in two respective transversal planes oriented in substantially radial directions towards the axis of rotation of the wheel, in the condition mounted on the vehicle. Each side face 18a, 18b of the backing plates 12b, 13b defines a respective radially extending or elongated side surface having a radial dimension greater than an axial dimension.

According to an embodiment, the stationary supporting portion 14 has an overall elongate shape in a longitudinal direction (FIG. 2), or in a tangential direction, considering the condition of the caliper in use, mounted on a vehicle, with reference to the direction of rotation of the brake disc. The stationary portion 14 can be considered as a spacer or adapter, which may be made in different sizes and shapes, in order to fit the caliper, adapting it to different vehicles.

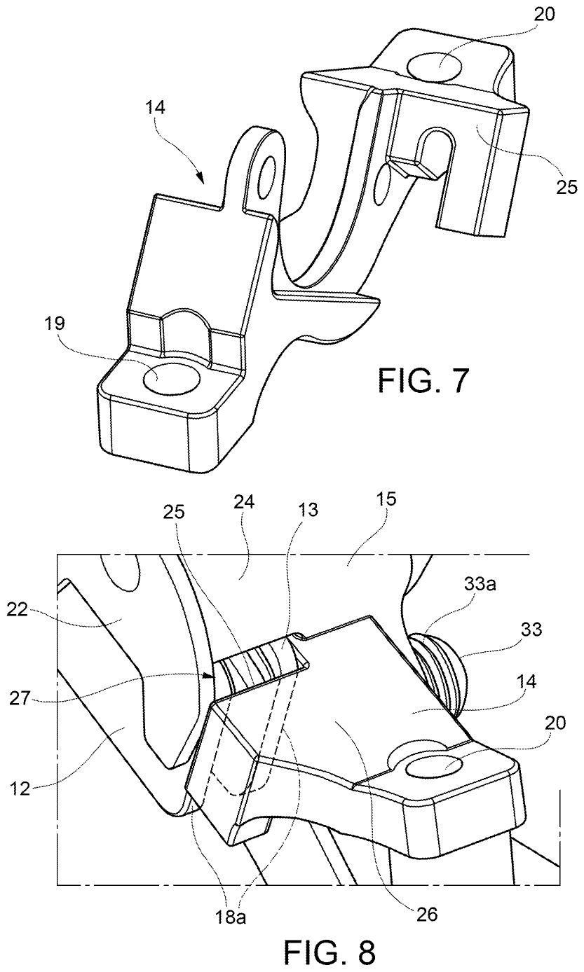

The stationary portion 14 may have at its ends two holes 19, 20 (FIG. 7) or other means or mounting seats that allow the stationary supporting portion 14, and thus the brake caliper 10, to be fixed to the vehicle chassis.

Preferably, the stationary supporting portion 14 is made of metal material, such as aluminium or steel, to ensure a strong and stable attachment to the vehicle.

In a floating brake caliper 10, the sliding block 15 can slide with respect to the stationary portion 14 in an axial direction, i.e. along a direction parallel to the transversal axis x.

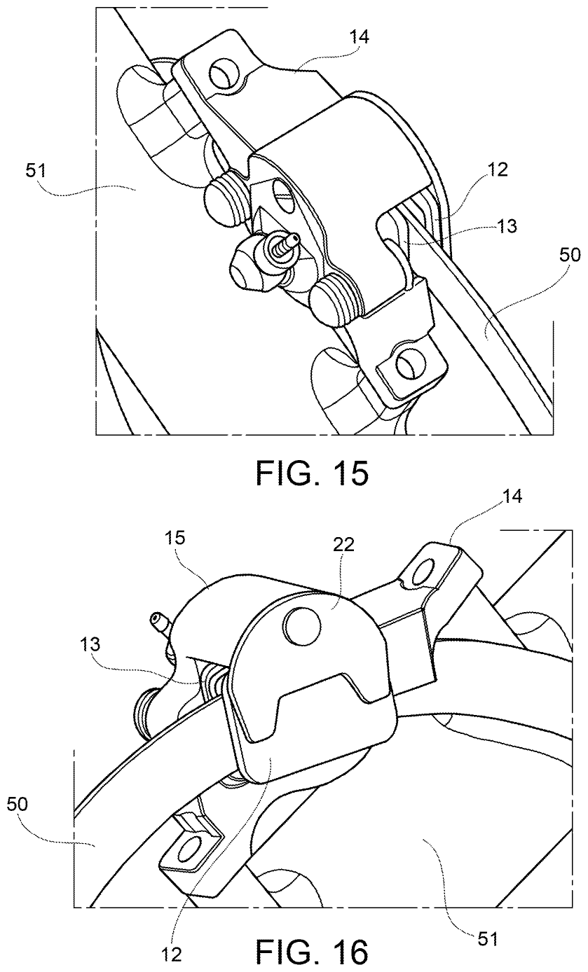

The sliding block 15 is axially slidable in the direction of the stationary portion 14 and is configured to straddle a peripheral part of a rotating brake disc in use (FIGS. 15, 16).

As shown in FIG. 6, the sliding block 15 has an overall substantially C-shape, with two axially spaced side wings 15a, 15b connected by a connecting portion 15c. A space or gap 15d is identified between the side wings 15a, 15b and the connecting portion 15c. The space 15d accommodates the two brake pads 12, 13 between the side wings 15a, 15b and allows, in use, the passage of a peripheral part of the brake disc between the brake pads.

The side wings 15a, 15b, the connection portion 15c and the gap 15d of the sliding block 15 are formed by several components assembled together: two opposite end plates 21, 22, a connection element 23 and a plastic body 24 which is clamped between the end plates 21, 22.

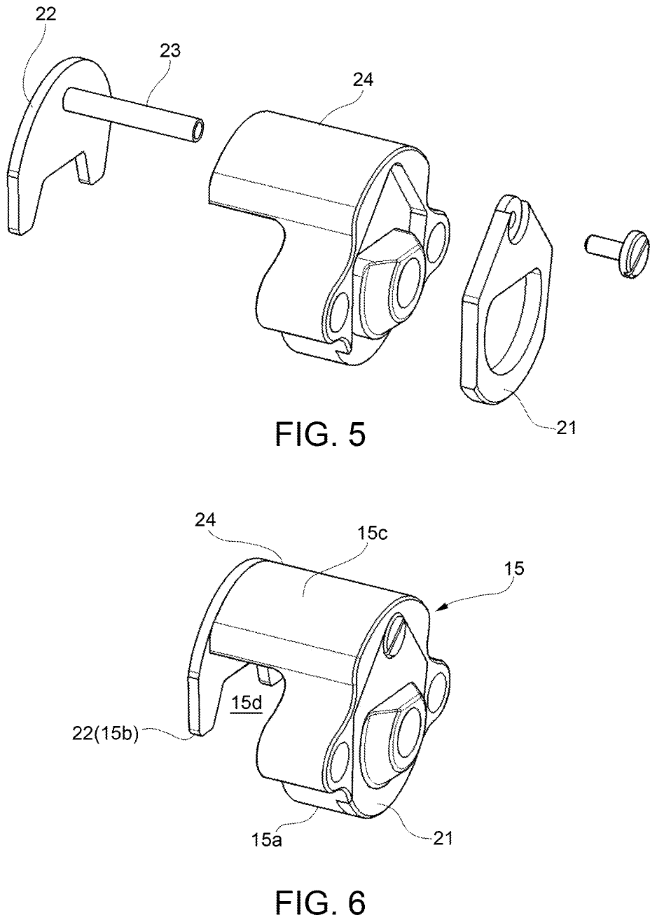

As illustrated in FIGS. 5 and 6, the sliding block 15 comprises two opposite end plates 21, 22, axially spaced form one another and arranged at respective axially or transversally opposite ends of the sliding block 15: a first end plate 21 and a second end plate 22. The sliding block 15 further comprises an axial or transversal connecting element 23, which rigidly connects the two end plates 21, 22 to one another, and a body 24 of plastic material which is interposed and firmly locked by the connecting element 23 between the first end plate 21 and the second end plate 22.

The end plates 21, 22 and the connecting element 23 are made of a metal material, conveniently steel.

The end plates 21, 22 extend in respective geometric planes perpendicular to the transversal axis x and transversally spaced. The connecting element 23 extends axially to rigidly join the end plates 21, 22 to each other. The end plates 21, 22 are axially spaced so as to lie on respective opposite sides of the brake disc in the mounted condition.

Advantageously, the connecting element 23 may be shaped as a transversally elongated pin or rod which, in addition to performing the structural function of connecting the end plates 21, 22, can also serve to mount the brake pads 12, 13. For this purpose, the backing plates 12b, 13b may have a respective through-hole 12d, 13d (FIG. 3), in which the connecting pin 23 may be inserted.

The sliding block 15 further comprises a rigid body 24 of plastic material which is interposed and locked by the connecting element 23 between the first end plate 21 and the second end plate 22.

Operation of a floating brake caliper is to be considered generally known; therefore, in the following part of this description, only those elements relevant to the implementation of the floating brake caliper according to the invention will be described. For the implementation of parts and elements not illustrated in detail, for example hydraulic connections, reference may be made to any solution relating to a floating brake caliper of known design.

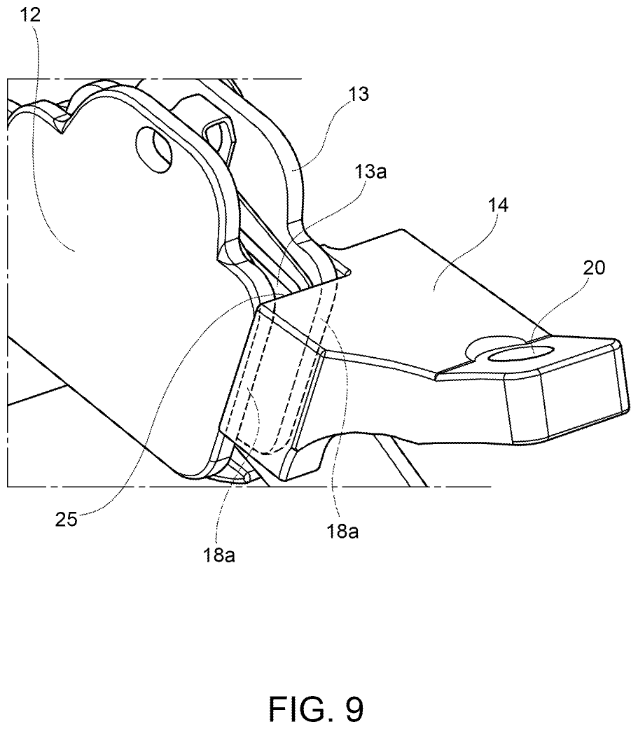

The stationary portion 14 of the brake caliper 10 comprises at least one abutment surface 25 (FIG. 7) which is made so as to face one (the side face 18a) of the two side faces 18a, 18b of each backing plate 12b, 13b (FIGS. 8 and 9).

The abutment surfaces 25 and the side face 18a of each backing plate 12b, 13b may be flat. Alternative embodiments (not shown) may provide that the abutment surfaces 25 of the stationary supporting portion 14 and the side face 18a of each backing plate 12b, 13b have corresponding, at least partially mating shapes to form an extended contact surface for more efficient transmission of the braking loads. For example, the surfaces 25a and 18a may have a corresponding and concordant curvature.

The bearing surface 25 may be presented by a protruding portion 26 (FIG. 8) of the stationary supporting portion 14.

In an alternative embodiment, the stationary portion 14 may be formed as a mono-block having a single abutment surface 25. In an alternative embodiment, the abutment surface 25 may comprise at least two disjointed and/or parallel surfaces. In another embodiment, which is not illustrated, the abutment surface 25 may be obtained on an element formed separately from the stationary portion 14, and be solidly attached thereto by means of a mechanical fastener such as a screw or bolt, or by interlocking. Other embodiments may provide for the stationary portion 14 to be formed as a single piece with the bicycle fork.

The rigid body 24 of plastic material has a recess 27 which forms the space or gap 15d between the side wings 15a, 15b to accommodate the brake pads and allows, in use, the passage of a peripheral part of the brake disc between the pads. The recess 27 is configured in such a way that the side 18a of each backing plate 12b, 13b can reach a stable abutment position against the abutment surface 25 of the stationary supporting portion 14 during braking.

Being made of plastic, the rigid body 24 may advantageously be manufactured by injection moulding using materials such as polyamide (PA66). In particular, polyamide reinforced with glass or carbon fibres in different percentages, e.g. 30% or 50% (PA66GF30, PA66GF50) may be used.

According to an embodiment, the rigid body 24 may have an overall L-shape, comprising an upper 28 (or radially outer) part and a side part 29 (FIGS. 7 and 8).

The upper part 28 of the rigid body 24 may extend in a substantially axial direction and may have a curved shape to match the shape of the backing plates 12b, 13b of the brake pads 12, 13.

Furthermore, the upper part 28 may be provided as a bridge formation that allows the first end plate 21 and the second end plate 22 to be connected on opposite sides of the rigid body 24.

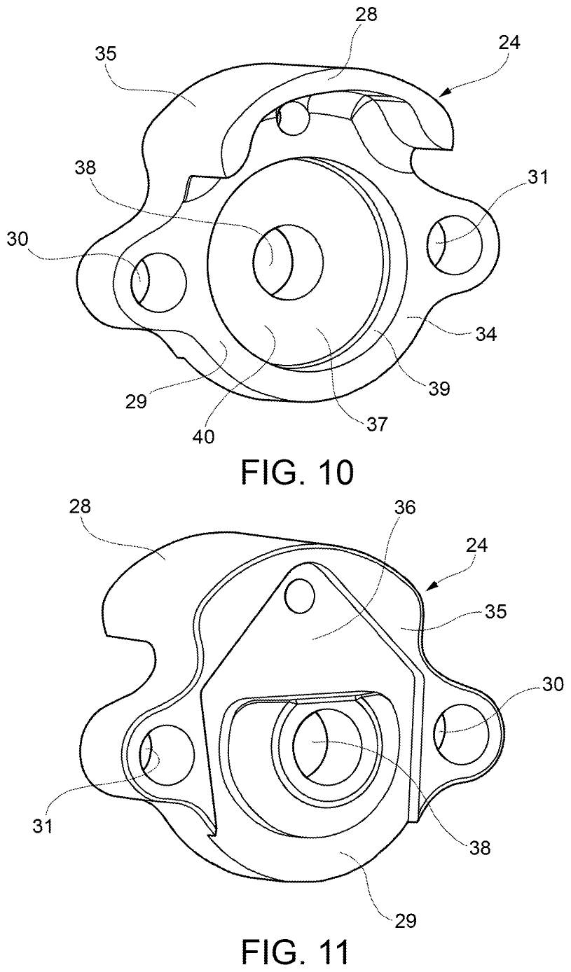

The lateral part 29 (FIG. 1) of the rigid body 24 may develop in the longitudinal direction and may have at least two through holes 30, 31 (FIG. 10), which are spaced apart and opposite with respect to the transversal axis x. Preferably, the two holes 30, 31 may be parallel to the transversal axis x.

As shown in FIG. 12, the brake caliper 10 may also comprise two pins 32, 33 fixed and integral to the stationary supporting portion 14. The pins 32, 33 may pass through the two holes 30, 31 passing through the side portion 29 of the rigid body 24, thus, may guide the axial movement of the sliding block 15 with respect to the stationary supporting portion 14 during braking.

Pins 32, 33 may be horizontally oriented, i.e. they may be substantially parallel to the transversal axis x, and spring elements 32a, 33a may be interposed between them and the rigid body 24.

The rigid body 24, being interposed and locked by the connecting element 23 between the first plate 21 and the second plate 22, remains integral with them.

The rigid body 24 has an inner surface 34 facing the piston 11 and the brake pads 12, 13, and an outer surface 35 opposite the inner surface 34 (FIGS. 10 and 11). The outer surface 35 may have an outer recess 36 and the inner surface 34 may have an inner cylindrical cavity 37.

Preferably, the rigid body 24 forms an axial passage 38 extending from the outer surface 35 to the inner surface 34. In particular, the passage 38 connects the outer surface 35 with the inner cylindrical cavity 37.

The manufacture of the rigid body 24 from plastic by injection moulding is particularly advantageous for obtaining a one-piece, low-weight rigid body. Furthermore, manufacture by moulding is advantageous in terms of time and processing costs, making the brake caliper more economical. In fact, this technology allows the rigid body 24 to form the outer recess 36, the cylindrical cavity 37 and the passage 38 through a single step, without requiring subsequent steps, and without removal of material.

The outer recess 36 on the outer surface 35 of the rigid body 24 may be configured to accommodate the first plate 21 (FIG. 3). In particular, the outer recess 36 may have a shape mating a contour 21a or edge of the first plate 21 to accommodate and block the first plate 21, preventing relative movement thereof with respect to the rigid body 24.

The inner cylindrical cavity 37 on the inner surface 34 of the rigid body 24 may have a cylindrical side wall 39 and a base wall 40 (FIG. 10). The inner cylindrical cavity 37 is configured to accommodate, at least partially, the piston 11 and form with it a hydraulic chamber 41 for receiving and actuating the piston 11. In particular, the inner cylindrical cavity 37 may have a diameter substantially corresponding to a diameter of the piston 11.

The passage 38 may be provided through the side part 29 of the rigid body 24 coaxial with the transversal axis x. The passageway 38 is preferably cylindrical, so as to accommodate at least one hydraulic connector 42 and put an admission channel 43 in fluid communication with the hydraulic chamber 41 (FIG. 13).

During braking, brake fluid passes from the inlet channel 43 to the hydraulic chamber 41 expanding it, and thereby actuating the floating brake caliper 10. Specifically, during braking, the piston 11 is urged in an axial direction towards the brake pad 13, which approaches a braking surface of the brake disc. As a result of the pressure of the brake fluid in the hydraulic chamber, the rigid body 24 and the first end plate 21 move in an axial direction opposite to the piston, bringing the second end plate 22 and the brake pad 12 towards a second face of the brake disc, opposite to the first.

The brake pad 10 may further comprise at least one annular elastic sealing element 44 (FIGS. 12 and 13), typically having a rectangular or square cross-sectional area, capable of providing a sliding contact seal between the cylindrical surface 16 of the piston 11 and the cylindrical wall 39 of the inner cylindrical cavity 37 of the rigid body 24.

In a preferred embodiment (FIG. 13), the annular sealing element 44 is partially accommodated in a groove 45 made in the cylindrical surface 16 of the piston 11. In such an embodiment, the elastic annular sealing element 44 acts in sliding contact against the cylindrical wall 39 of the inner cylindrical cavity 37 of the rigid body 24. This embodiment is particularly advantageous when the rigid body 24 is obtained through a moulding process because the cylindrical surface 39 of the inner cylindrical cavity 37 of the rigid body can be made smooth and free of undercuts, without requiring additional machining of the component, and using a mould of simplified shape.

The sealing element 44 may be mounted in a radially compressed condition between the groove 45 on the piston 11 and the cylindrical wall 39 of the rigid body 24. During braking, the sealing element 44 is elastically deformed in an axial direction due to relative axial movement of the piston 11 and the rigid body 24 in opposite directions. Once the braking action has ceased, the elastic element 44 resumes its undeformed condition, urging the piston 11 away from the brake pad 13, which is in turn pushed away from the braking surface of the brake disc by a spring 46. At the same time, the rigid body 24 and the first plate 21 are moved in an axial direction opposite to that of the piston 11, urging the second plate 22 away from the brake pad 12, which is in turn urged away from the braking surface of the brake disc by the spring 46. This pushing away of the brake pads 12, 13 from the brake disc can be advantageously accentuated by a releasing action of the spring elements 32a, 33a mounted between the pins 32, 33 and the rigid body 24.

In an alternative embodiment (FIG. 14), the groove 45 accommodating the annular elastic sealing element 44 may be made on the cylindrical wall 39 of the inner cylindrical cavity 37 of the rigid body 24. In such an embodiment, the sealing elements may act against the cylindrical surface 16 of the piston 11.

In an embodiment, the brake caliper 10 may be attached to a frame 51 (FIGS. 15 and 16) of a two-wheeled vehicle by means of the stationary supporting portion 14 and may be arranged to straddle a brake disc 50 such that the friction material layer 12a, 13a of the brake pads 12, 13 respectively face each of the two opposing braking surfaces of the brake disc 50.

As will be appreciated, it is advantageous that the abutment surface 25 for the brake pads is provided by the metal stationary portion of support 14, which is rigidly fixed (or integral) to the fork, and not by the caliper body as on conventional non-floating brake calipers. In this floating caliper, the caliper body is only stressed by the hydraulic pressure exerted by the compression force of the pads on the disc and is not stressed by the transfer of braking torque to the fork.

Although specific embodiments of the invention have been disclosed, it must be understood that this disclosure is provided purely for illustrative purposes and that the invention is not to be limited in any way by it. Various modifications will become apparent to those skilled in the art in the light of the above examples. The scope of the invention is limited only by the appended claims.

1. A brake caliper for a two-wheel vehicle, the brake caliper defining a transversal axis, and comprising:
at least one piston;
two brake pads axially movable and configured to be arranged in use facing two opposite brake disc braking surfaces, each brake pad having a backing plate provided with a pair of opposing side faces extending in use in a direction substantially radial to an axis of rotation of a wheel of the two-wheel vehicle;
a stationary supporting portion made of metal material and securable to or integral with the two-wheel vehicle, the stationary supporting portion comprising at least one abutment surface facing in use one side face of said pair of opposing side faces of each backing plate; and
a sliding block, axially slidable with respect to the stationary supporting portion, the sliding block being configured to be arranged, in use, straddling a brake disc, the sliding block having an overall C-shape with two side wings connected by a connecting portion, with a space defined between the two side wings and the connecting portion, wherein said space accommodates the two brake pads between the two side wings and allows a passage of a peripheral part of the brake disc between the two brake pads;
wherein the sliding block comprises
a first end plate and a second end plate composing a respective one of said two side wings arranged in use on opposite sides of the brake disc;
a connecting element rigidly connecting the first end plate and the second end plate; and
a rigid body made of a plastic material, which is interposed and locked between the first end plate and the second end plate and forms a recess which provides the space accommodating the two brake pads, and
wherein said side face of each backing plate has an abutment position against the abutment surface of the stationary supporting portion through the recess of the rigid body during braking.

2. The brake caliper of claim 1, wherein the rigid body comprises an outer surface, an inner surface opposite the outer surface and facing the at least one piston, at least one inner cylindrical cavity formed in the inner surface for accommodating partially the at least one piston and defining a hydraulic chamber therewith, and an axial passage extending between the inner cylindrical cavity and the outer surface to establish fluid communication between the hydraulic chamber and a hydraulic connector for conveying brake fluid to the brake caliper.

3. The brake caliper of claim 1, wherein the rigid body comprises an outer surface, an inner surface opposite the outer surface and facing the at least one piston, and an outer recess formed in the outer surface of the rigid body and configured for accommodating the first end plate.

4. The brake caliper of claim 3, wherein the outer recess of the rigid body has a shape matching a contour of the first end plate to accommodate and lock the first end plate, preventing relative movement thereof with respect to the rigid body.

5. The brake caliper of claim 2, further comprising at least one resilient annular sealing element mounted in a groove formed in a cylindrical surface of the at least one piston and acting in sliding contact against a cylindrical wall of the inner cylindrical cavity.

6. The brake caliper of claim 1, further comprising at least two axially elongated pins fixed to and integral with the stationary supporting portion, configured for guiding an axial movement of the sliding block relative to the stationary supporting portion.

7. The brake caliper of claim 1, wherein the connecting element is an axially elongated pin that joins the first end plate with the second end plate.

8. The brake caliper of claim 1, wherein the stationary supporting portion is formed as a single piece integrally with a fork of the two-wheel vehicle.
